(19) United States
(12) Patent Application Publication
(10) Pub. No.: US 2024/0416317 A1
(43) Pub. Date: Dec. 19, 2024

(54) AMINE-MODIFIED METAL ORGANIC FRAMEWORK COMPOSITION

(71) Applicant: EXXNMOBIL TECHNOLOGY AND ENGINEERING COMPANY, Annandale, NJ (US)

(72) Inventors: Aaron W. PETERS, New Hope, PA (US); Simon C. WESTON, Annandale, NJ (US); Hilda B. VROMAN, Piscataway, NJ (US)

(21) Appl. No.: 18/666,267

(22) Filed: May 16, 2024

Related U.S. Application Data
(60) Provisional application No. 63/507,811, filed on Jun. 13, 2023.

(51) Int. Cl. B01J 20/22; B01D 53/04

(52) U.S. Cl. CPC B01J 20/226; B01D 53/04; B01D 2253/204; B01D 2253/342; B01D 2257/504; B01J 2220/46

(57) ABSTRACT

An amine-modified metal-organic framework composition is provided that has beneficial properties for performing direct air capture. The composition corresponds to a mixed-metal organic framework that includes 4,4′-dioxidobiphenyl-3,3′-dicarboxylate (dobpdc) as the linker. The mixed metals can correspond to two or more metals. In some aspects, the mixed-metal organic framework corresponds to M¹ₓM²₍₂₋ₓ₎ (dobpdc). In various aspects, the mixed-metal organic framework is appended with N,N′-diethylethylenediamine (e-2-e).

### CROSS-REFERENCE TO RELATED APPLICATION

This Non-Provisional patent application claims priority to U.S. Provisional Patent Application No. 63/507,811, filed Jun. 13, 2023, and titled “AMINE-MODIFIED METAL ORGANIC FRAMEWORK COMPOSITION”, the entire contents of which is incorporated herein by reference.

### FIELD

An amine-appended metal-organic framework composition is provided that has improved properties for sorption of CO₂.

### BACKGROUND

Direct air capture is an area of increasing interest as a method of managing CO₂. Instead of having to co-locate CO₂ capture equipment with a potential source of CO₂, a direct air capture process can be located at any location that is deemed convenient and/or practical for performing the capture process. However, a variety of challenges remain.

Some of the challenges for performing direct air capture, such as by using a sorbent in a cyclic sorption/desorption process, are due to the dilute nature of CO₂ in air. The CO₂ concentration in air is typically near 400 vppm (volume parts per million). This can severely limit the design options for a direct air capture system due to practical considerations. First, the direct air capture system needs to be able to sorb CO₂ from the air in reasonable quantities and on reasonable time scales. However, due to the highly dilute concentration of CO₂ in air, even modest manipulation of the temperature and/or pressure of the air assist with desorption can result in escalating energy/capital/operational costs. Alternatively, attempting to remove CO₂ from air without manipulating the temperature and/or pressure of the air can severely limit the options with regard to sorbents. The options for sorbent systems are further limited by the need to be able to subsequently desorb CO₂ in order to regenerate the sorbent for the next sorption/desorption cycle. It would be desirable to have further improvements in sorption/desorption processes and/or in sorbent systems for use in such processes that can reduce or minimize the costs associated with performing direct air capture.

U.S. Patent Application Publication 2022/0176343 describes mixed-metal organic framework systems for selective CO₂ capture. Some examples of mixed-metal organic frameworks described in the reference include M¹ₓM²₍₂₋ₓ₎A, where A is a disalicylate linker. An example of such a mixed-metal organic framework is M¹ₓM²₍₂₋ₓ₎ (dobpdc), where dobpdc corresponds to 4,4′-dioxidobiphenyl-3,3′-dicarboxylate. M¹ₓM²₍₂₋ₓ₎ (dobpdc) can also be referred to as EMM-67. Examples of mixed-metal organic frameworks with appended polyamines are also described. U.S. Pat. No. 11,014,067 describes appending polyamines to metal organic frameworks.

A journal article by Siegelman et al. (J. Am. Chem. Soc. 2017, 139, 30, 10526-10538) describes CO₂ Adsorption in amine appended Mg₂(dobpdc) metal organic frameworks. One example material described in the reference is Mg₂(dobpdc) that is appended with N,N′-diethylethylenediamine. It is noted that in the Supplemental Materials for the Siegelman et al. article, a desorption isobar is presented for a N,N′-diethylethylenediamine material. The desorption isobar shows that a temperature above 140° C. is needed to achieve substantially complete desorption. However, increasing the temperature above 140° C. also results in additional loss of material below the original weight of the amine appended material. It is believed that this additional loss of material indicates desorption of the amine itself at the temperatures required for substantially complete desorption of CO₂ from the material.

A journal article by Park et al. (ACS Appl. Mater. Interfaces 2020, 12, 45, 50534-50540) describes adsorption of CO₂ at 1000 vppm using Mg₂(dobpdc) that is appended with various types of amines. The step positions in the sorption isotherms for these materials are at locations where little or no adsorption would be expected at CO₂ concentrations of less than 600 vppm.

A journal article by McDonald et al. (J. Am. Chem. Soc. 2012, 134, 16, 7056-7065) describes Mg₂(dobpdc) appended with N,N′-dimethylethylenediamine. The material was exposed to 390 vppm of CO₂ in N₂ at 25° C. and roughly atmospheric pressure. After 1 hour, the material showed a CO₂ uptake of 1.05 mmol CO₂/g, as compared with a theoretical equilibrium capacity of 4 mmol CO₂/g.

### SUMMARY

In an aspect, a sorbent composition including a mixed-metal organic framework is provided. The mixed-metal organic framework includes two or more metals selected from Mg, Ca, Sc, Ti, V, Mn, Cr, Fe, Co, Ni, Cu and Zn, and a linker corresponding to 4,4′-dioxidobiphenyl-3,3′-dicarboxylate, 3,3′-dioxidobiphenyl-4,4′-dicarboxylate, or a combination thereof. The mixed-metal organic framework further includes N,N′-diethylethylenediamine. Optionally, the mixed-metal organic framework is represented by the formula M¹ₓM²₍₂₋ₓ₎ 4,4′-dioxidobiphenyl-3,3′-dicarboxylate, where M¹ is different from M² and where x is from 0.01 to 1.99, or 0.1 to 1.9, or 0.5 to 1.5. Optionally, the sorbent composition can be supported on at least one of a monolith, particles of a packed bed, a hollow fiber, or a combination thereof.

In another aspect, a method for separating CO₂ from a feed is provided. The method includes contacting a sorbent composition in a sorbent environment with an input flow comprising 600 vppm or less of CO₂ to form a CO₂-loaded sorbent and a sorption output flow with a CO₂ content lower than the CO₂-containing input flow. The sorbent composition can include a mixed-metal organic framework, where the mixed-metal organic framework includes two or more metals selected from Mg, Ca, Sc, Ti, V, Mn, Cr, Fe, Co, Ni, Cu and Zn, and a linker corresponding to 4,4′-dioxidobiphenyl-3,3′-dicarboxylate, 3,3′-dioxidobiphenyl-4,4′-dicarboxylate, or a combination thereof. The mixed-metal organic framework further includes N,N′-diethylethylenediamine.

### BRIEF DESCRIPTION OF THE DRAWINGS

FIG. 1 shows CO₂ adsorption isotherms of EMM-53(3-2-3), EMM-53(3-3-3), EMM-53(3-4-3), and EMM-50(e-2-e) at 75° C.

FIG. 2 shows CO₂ adsorption isobars collected at 35° C.

FIG. 3 shows variable temperature uptake of CO₂ on EMM-50(e-2-e) with a stream containing 400 vppm of CO₂.

FIG. 4 shows variable temperature uptake of CO₂ on EMM-53(3-4-3) with a stream containing 400 vppm of CO₂.

FIG. 5 shows variable temperature uptake of CO₂ on EMM-53(3-3-3) with a stream containing 400 vppm of CO₂.

FIG. 6 shows cyclic sorption and desorption of CO₂ on EMM-50(e-2-e).

### DETAILED DESCRIPTION

All numerical values within the detailed description and the claims herein are modified by “about” or “approximately” the indicated value, and take into account experimental error and variations that would be expected by a person having ordinary skill in the art.

### Overview

In various aspects, an amine-modified metal-organic framework composition is provided that has beneficial properties for performing direct air capture. The composition corresponds to a mixed-metal organic framework that includes 4,4′-dioxidobiphenyl-3,3′-dicarboxylate (dobpdc) as the linker. The mixed metals can correspond to two or more metals. In some aspects, the mixed-metal organic framework corresponds to M¹ₓM²₍₂₋ₓ₎ (dobpdc). In various aspects, the mixed-metal organic framework is appended with N,N′-diethylethylenediamine (e-2-e). Such a mixed-metal organic framework where the linker is dobpdc and that is appended with N,N′-diethylethylenediamine may be referred to herein as EMM-50(e-2-e).

It has been discovered that EMM-50(e-2-e) has an unexpected combination of properties. The unexpected combination of properties includes a high driving force for rapidly adsorbing CO₂ under dilute conditions while still being able to desorb CO₂ during a desorption step under relatively mild conditions. This unexpected combination of properties is beneficial for direct air capture, as CO₂ can be rapidly adsorbed during a sorption step without substantial modification and/or pre-treatment of the incoming air stream. Additionally, during the desorption step of a cycle, the sorbed CO₂ can be desorbed while reducing or minimizing the energy costs associated with swings of temperature and/or pressure during desorption. The desorption conditions also allow the capacity of the sorbent system to be maintained over multiple cycles.

As a practical matter, it is desirable to be able to perform CO₂ sorption during a direct air capture process at a temperature relatively close to ambient temperature and pressure. Thus, the sorption temperature can typically be between 0° C. and 35° C. while the total pressure in the sorption environment can be near 100 kPa-a, depending on the location of the direct air capture facility.

In addition to sorbing CO₂, the combination of temperature and pressure required for desorbing CO₂ from a sorbent also plays a significant role in determining the viability of a direct air capture process. A sorbent with a strong driving force for CO₂ sorption under ambient conditions may be unsuitable for direct air capture if the conditions required for desorption involve excessively high temperatures and/or excessively low pressures. For conventional materials, the factors resulting in better sorption typically are the same factors that result in difficulties with desorption, as a high driving force of sorption of CO₂ at low partial pressures typically corresponds with a high enthalpy of sorption. This results in higher temperatures/lower sub-ambient pressures during desorption, thus increasing the energy and operation costs for the sorption desorption cycle.

It has been discovered that EMM-50(e-2-e) provides an unexpectedly favorable combination of properties relative to conventional materials for direct air capture. The driving force for sorption of CO₂ is strong at CO₂ partial pressures near 400 vppm, allowing for rapid uptake of CO₂ during a sorption step. However, in spite of the strong driving force for CO₂ uptake, the shape of the sorption/desorption isotherm for EMM-50(e-2-e) allows for desorption of CO₂ under conditions of sufficiently low severity so that the degradation of the capacity of the sorbent is reduced or minimized. For example, the desorption temperature can be sufficiently low to reduce or minimize desorption of the EMM-50(e-2-e) while still allowing for substantially complete desorption of CO₂. This allows the capacity within a single cycle to be increased or maximized while also reducing or minimizing any losses in sorption capacity due to loss of the amine. As a result, EMM-50(e-2-e) can be used to improve existing direct air capture processes by substantially reducing the time required for sorption of a specified quantity of CO₂ without requiring increased costs for desorption.

In various aspects, the mixed-metal organic framework based on the linker dobpdc and appended with N,N′-diethylethylenediamine (i.e., EMM-50(e-2-e)) can include two or more metals selected from Mg, Ca, Sc, Ti, V, Mn, Cr, Fc, Co, Ni, Cu and Zn. In some aspects, the mixed-metal organic framework can include two or more metals selected from Mg, Ca, V, Mn, Cr, Fe, Co, Ni, Cu and Zn. In some aspects, the two or more metals can be selected from Ni, Mn, Mg, and Zn. In an aspect, the metals can be Mn and Mg.

In some aspects, the mixed-metal organic framework can include two metals, so that it is represented by the formula M¹ₓM²₍₂₋ₓ₎ (dobpdc), where M¹ is different from M² and where x can range from 0.01 to 1.99, or 0.1 to 1.9, or 0.5 to 1.5. As noted above, “dobpdc” is 4,4′-dioxidobiphenyl-3,3′-dicarboxylate. Optionally, M¹ can be Mn and M² can be Mg.

It is noted that switching the positions of the carboxylic acids and the alcohols in dobpdc results in a linker that forms a metal organic framework with the same topology. In other words, an alternative linker that can be used is a linker where the hydroxyl groups are located on carbons 3 and 3′, while the carboxylic acid groups are located on carbons 4 and 4′. This alternative linker can be referred to as “pc-dobpdc”. Appending e-2-e to a mixed-metal organic framework formed using this alternative linker is believed to result in an amine-appended metal organic framework with properties similar to EMM-50(e-2-e), based on the similar topology.

To form EMM-50(e-2-e), the mixed-metal organic framework can be appended or otherwise associated with N,N′-diethylethylenediamine. It is noted that EMM-50(e-2-e) does not specify an amount or percentage of the polyamine e-2-e that is appended relative to the number of potential bonding sites. In the metal organic framework structure, each metal atom site corresponds to a potential site for interaction/association with an amine group. Thus, at full loading (100%), the number of appended/associated diamines would equal the number of metal atom sites. The mixed-metal organic framework can be appended with any convenient amount of the diamine, such as an amount that corresponds to 1.0% to 100% of the available interaction sites for an amine, or 1.0% to 80% of the available interaction sites, or 1.0% to 65%, or 20% to 100%, or 20% to 80%, or 20% to 65%, or 40% to 100%, or 40% to 80%, or 40% to 65%. The loading of amine relative to metal sites can be determined, for example, by nuclear magnetic resonance spectroscopy (NMR) via digestion of a mg of the sample in a DCI/D6-DMSO mixture and integration of the 1H-NMR signals of the MOF ligand and comparing to the integration of the signals associated with the amine.

One option for preparing an amine-appended mixed-metal organic framework system, such as EMM-50(e-2-e), is to use a two-step process. In a first step, a suitable salt of M¹ and a suitable salt of M² are combined with the linker (dobpdc) in an appropriate solvent and heated to provide a mixed-metal organic framework system general. For example, MnCl₂·4H₂O and Mg(NO₃)₂·6H₂O can be combined with 4,4′-dioxidobiphenyl-3,3′-dicarboxylate in methanol and N,N′-dimethylformamide (DMF) to provide a mixed-metal organic framework composition corresponding to MgₓMn₂₋ₓ(dobpdc). In a second step, the mixed-metal organic framework can be combined with the ligand N,N′-diethylethylenediamine in a suitable solvent, such as toluene.

In this discussion, the “sorbent environment” is defined as the volume within a vessel that contains the sorbent used for performing a sorption/desorption cycle. When multiple vessels are present, such as vessels arranged in parallel to allow continuous processing of a gas flow by having different portions of the sorbent in different stages of the process cycle, each vessel is defined as a separate sorbent environment. It is noted that a “vessel” can correspond to a portion of a conduit that contains the sorbent, even though the conduit does not otherwise change size upstream or downstream from the portion of the conduit that contains the sorbent.

In this discussion, sorption is defined as including both adsorption and absorption. Adsorption refers to physical association of a component with a surface or active site, such as physisorption of CO₂ on a solid surface. Absorption corresponds to a physical or chemical incorporation of component into a different phase, such as incorporation of gas phase CO₂ into a complex with a liquid phase amine. Desorption is defined as separation of an adsorbed or absorbed component from the adsorption surface or absorption phase.

Process for Sorption of CO₂ from Dilute Feed Streams

In various aspects, EMM-50(e-2-e) can be used for sorption of CO₂ from dilute feed streams, such as a stream containing 600 vppm or less of CO₂. In some aspects, a dilute CO₂-containing stream can have a CO₂ content of 200 vppm to 600 vppm, or 200 vppm to 500 vppm, or 300 vppm to 600 vppm, or 300 vppm to 500 vppm. As an example, air typically has a CO₂ concentration of roughly 400 vppm.

In various aspects, sorption from a dilute feed stream can be performed at a total pressure of 80 kPa-a to 500 kPa-a, or 80 kPa-a to 200 kPa-a, or 80 kPa-a to 120 kPa-a, or 90 kPa-a to 500 kPa-a, or 90 kPa-a to 200 kPa-a, or 90 kPa-a to 120 kPa-a. Additionally or alternately, the temperature in the sorbent environment during sorption from a dilute feed stream can be between 0° C. to 70° C., or 0° C. to 50° C., or 0° C. to 35° C. It is noted that sorption at temperatures below 0° C. may also be feasible, so long as ice formation does not pose problems within the sorbent environment. In such aspects, a temperature of −15° C. to 70° C. can be used, or −15° C. to 50° C., or −15° C. to 35° C.

During sorption of CO₂ from a dilute stream having a CO₂ concentration of 600 vppm or less, EMM-50(e-2-e) can rapidly sorb CO₂ up to substantially the maximum loading of CO₂ for the material at a given temperature in relatively short time. For example, at temperatures of 0° C. to 70° C. or less and total pressures of 150 kPa-a or less, during exposure of EMM-50(e-2-e) to a stream containing 600 vppm or less of CO₂, EMM-50(e-2-e) can achieve a CO₂ loading corresponding to 80% or more of the equilibrium loading at the sorption temperature in 15 minutes or less (or 85% or more, or 90% or more, such as up to 100%). For purposes of this definition, the equilibrium loading at a given temperature and partial pressure of CO₂ corresponds to a loading that would be achieved by exposure at the specified temperature and partial pressure after a period of 8 hours. This is an unexpected outcome in contrast to conventional amine-appended metal organic framework materials, which typically require exposure times of an hour or more to achieve 90% of an equilibrium loading of CO₂ when attempting to sorb CO₂ from a dilute stream.

It is noted that EMM-50(e-2-e) can also be used for sorption of CO₂ from streams with higher CO₂ concentrations. More generally, EMM-50(e-2-e) can be used for sorption of CO₂ from stream containing 0.01 vol % CO₂ (100 vppm) to 25 vol % CO₂, or possibly still higher. Additionally, sorption can be performed at a variety of temperatures and/or pressures, depending on the nature of the CO₂-containing stream. For example, sorption of CO₂ can be performed at temperatures of up to 100° C. or possibly still higher, and/or at total pressures ranging from 50 kPa-a to 5 MPa-a, or possibly still higher.

After exposing a sorbent containing EMM-50(e-2-e) to a CO₂-containing stream, the sorbent can be regenerated by desorbing at least a portion of the CO₂. A variety of options are available for desorption of CO₂. One option is to perform desorption at a total pressure similar to the pressure used during sorption while increasing the temperature. In this type of process, substantially complete CO₂ desorption can be achieved by increasing the temperature of the sorbent environment to a temperature of up to 140° C., such as 100° C. to 140° C. It is noted that achieving substantially complete desorption at a temperature of 140° C. or less at pressures near 100 kPa-a is facilitated by the nature of the sorption/desorption isobar for EMM-50(e-2-e). In some aspects, desorption at a temperature of 140° C. or less can be performed at a pressure of 80 kPa-a to 150 kPa-a, or 80 kPa-a to 120 kPa-a, or 90 kPa-a to 150 kPa-a, or 90 kPa-a to 120 kPa-a. It is noted that partial regeneration can also be performed, if desired, so that a portion of the CO₂ loading remains on the sorbent at the end of the desorption step of a sorption/desorption cycle.

Additionally or alternately, desorption can be facilitated at least in part by reducing the pressure in the sorbent environment during desorption. This can reduce the temperature that is needed during desorption of CO₂. In various aspects where pressure reduction in the sorbent environment is used to assist with desorption, the total pressure in the sorbent environment during desorption of CO₂ can be 110 kPa-a or less, or 100 kPa-a or less, or 90 kPa-a or less, or 80 kPa-a or less, or 60 kPa-a or less, or 40 kPa-a or less, such as down to 1.0 kPa-a or possibly still lower. Additionally or alternately, in aspects where pressure reduction in the sorbent environment is used to assist with desorption, the total pressure during the desorption step of a sorption/desorption cycle can be lower than the total pressure during the sorption step by 10 kPa or more, or 20 kPa or more, or 50 kPa or more, or 100 kPa or more, such as up to 500 kPa or possibly still more. It is noted that still higher differences in pressure between desorption and sorption can be present in aspects where sorption is performed at pressures that are substantially above ambient pressure. In aspects where pressure reduction is used to facilitate desorption, the pressure during the desorption step can be 70° C. to 140° C., or 70° C. to 120° C., or 70° C. to 100° C., or 100° C. to 140° C., or 120° C. to 140° C.

In this discussion, the amount of CO₂ sorbed on a sorbent can be characterized based on the millimoles of CO₂ that are sorbed per gram of amine-based sorbent. For EMM-50(e-2-e), this corresponds to millimoles of CO₂ per gram of EMM-50(e-2-e). In this discussion, comparisons with other amine-appended metal organic framework materials are similarly provided on a millimoles of CO₂ per gram of amine-appended metal organic framework basis.

### Examples of Sorbent Environment

In order to facilitate exposure of the amine to a CO₂-containing gas, the amine can be supported or otherwise formed into a configuration that is stable in the presence of gas flows. One option for supporting an amine is to use a monolith or another type of contactor structure. As an example, a sorbent environment can include one or more monoliths that are designed to provide a large available surface area for contacting a gas flow with surfaces. Some types of monoliths have a plurality of channels passing through the monolith. The channels can be large enough so that a washcoat containing an amine can be coated on the interior surfaces of the channels. Optionally, the amines in the washcoat can be part of a larger compound or composition, such as a metal organic framework material with appended amines. Another option can be to use an amine-containing polymer (where at least a portion of the amines have substituted β-carbons) and coat the interiors of channels with a layer of the polymeric material. The monolith itself can be constructed from any convenient material that can support a washcoat or polymeric layer of amine or an amine-containing compound. Examples of monolith materials include refractory oxides (such as alumina), ceramics, metals, and polymers with sufficient structural stability to maintain shape in the presence of the conditions of a sorption/desorption cycle. It is noted that in aspects where the monolith is formed from a polymer, the monolith itself may include amines with substituted β-carbons that can perform sorption/desorption of CO₂. It is further noted that a sufficiently porous monolith may also be able to provide surface area in pores/pore channels of the monolith.

A variation on using a monolith can be to use a 3-D printed structure. Such a 3-D structure can be formed from various types of polymer materials. In some aspects, the 3-D printed structure can serve as a monolith, with an amine added to the surface of the monolith via washcoat or another convenient technique. In other aspects, the 3-D printed structure can have sufficient porosity so that amines incorporated into the volume of the 3-D printed structure can perform CO₂ sorption/desorption. Such amines can be part of the polymer used as the structural material, part of an additional material added to the ink used for making the 3-D printed structure (such as a metal organic framework material that includes appended amines), or a combination thereof.

Still another option can be to support an amine-containing material on objects (such as spheres) that can be used to form a packed bed. This option is similar to using a monolith, but with a reactor designed to allow the CO₂-containing gas to pass through the interstitial gaps between the particles of the packed bed, so that the gas can be exposed to amines supported on the surface/in the pores of the particles of the packed bed.

Yet another option can be to use a hollow fiber contactor. Hollow fibers can be formed from a variety of polymers. The polymer used as the structural material for forming the hollow fiber can include amines with substituted β-carbons, and/or an additional amine-containing material can be incorporated into the hollow fiber structure, such as a metal organic framework material with appended amines.

It is noted that for configurations where amines are appended to a material, such as a metal organic framework material, the amines can be appended at any convenient time. Thus, amines could be appended to a metal organic framework material after forming a contactor structure.

### Example 1—Synthesis of EMM-67 (Mixed-Metal Organic Framework)

As an example, one method for synthesis of mixed-metal organic framework MnₓMg₍₂₋ₓ₎(dobpdc), also referred to as EMM-67 is as follows: 241.15 mg of MnCl₂·4 H₂O (1.219 mmol), 312.65 mg of Mg(NO₃)₂·6H₂O (1.219 mmol), and 267.15 mg of 4,4′-dioxido-3,3′-biphenyldicarboxylate (dobpdc. 0.975 mmol) were combined in a 3-neck 250-mL round bottom flask with stir bar 49 mL deoxygenated methanol and N,N′-dimethylformamide (DMF) were transferred to the metal and ligand-containing solution while stirring. The solution was stirred for 20 minutes to ensure all solids were thoroughly dissolved. The reaction solution was split in 15 mL aliquots and transferred into 23-mL Teflon-lined Parr reactors. All reactors were sealed and heated at 120° C. for 96 hours under static conditions. Upon cooling naturally to ambient temperature, the mother liquor was removed by decantation, and the solid was washed three times over 24 hours with DMF, then three times over 24 hours with methanol. Approximately 40 mg of mixed-metal organic framework was collected, and the methanol was removed by slow centrifugation followed by pipetting.

### Example 2—Synthesis for EMM-50(e-2-e)

As an example of making EMM-50(e-2-e), EMM-67 synthesized according to Example 1 was used as a starting point. The EMM-67 was then reacted with N,N′-diethylethylenediamine to form the amine-appended mixed-metal organic framework EMM-50(e-2-e). Prior to reaction with the amine, the EMM-67 was vacuum dried at 70° C. for two hours. In a screw-top 100-mL jar, 60.5 g of toluene and 4.37 g of N,N′-diethylethylenediamine were added and stirred to combine. The EMM-67 (3.0 g) was then added to the solution and the slurry was stirred to combine. The EMM-67/toluene/amine solution was left to stir overnight at room temperature on a stir plate. Then, the resulting amine-appended mixed-metal organic framework material was recovered using gravity filtration and resubmerged in 75 g of toluene. The amine-appended mixed-metal organic framework/toluene slurry was allowed to sit for one hour before the amine-appended mixed-metal organic framework was recovered and washed using the same procedure three additional times. After the final wash, the resulting EMM-50(e-2-e) was dried in a 70° C. vacuum for 2 h. NMR quantification of the amine suggested 50-60% loading of amine based on the expected formula (e-2-e)₂MₓN₂₋ₓ(dobpdc).

### Example 3—Synthesis of Amine-Appended MOF-274 Organic Frameworks

EMM-67 was synthesized using a procedure identical to Example 1. The resulting EMM-67 was used to form three comparative amine-appended metal organic frameworks. The amines for these three additional materials are referred to herein as (3-2-3), (3-3-3), and (3-4-3). The amine (3-2-3) corresponds to N,N′-bis(3-aminopropyl)-1,2-ethylenediamine. The amine (3-3-3) corresponds to N,N′-bis(3-aminopropyl)-1,3-propanediamine. The amine (3-4-3) corresponds to N,N′-bis(3-aminopropyl)-1,4-diaminobutane. Prior to reaction with the amine, the EMM-67 was vacuum dried at 70° C. for two hours. In a screw-top 100-mL jar, 30 g of toluene and 1.9 g of the previously mentioned amine were added and stirred to combine. The EMM-67 (2.0 g) was then added to the solution and the slurry was stirred to combine. The EMM-67/toluene/amine solution was left to stir overnight at room temperature in the case of 3-2-3 and 3-3-3, while the 3-4-3 amination was conducted at 60° C. Then, the resulting amine-appended mixed-metal organic framework material was recovered using gravity filtration and resubmerged in 50 g of toluene. The amine-appended mixed-metal organic framework/toluene slurry was allowed to sit for one hour before the amine-appended mixed-metal organic framework was recovered and washed using the same procedure three additional times. After the final wash, the resulting aminated MOF was dried in a 70° C. vacuum for 2 h. NMR quantification of the amine suggested 100% loading of amine based on the expected formula (tetraamine)₂MₓN₂₋ₓ(dobpdc).

When EMM-67 is appended with a tetraamine, the resulting material can be referred to as EMM-53. Thus, the materials described in this example correspond to EMM-53(3-23), EMM-53(3-3-3), and EMM-53(3-4-3).

### Example 4—CO₂ Adsorption Tests

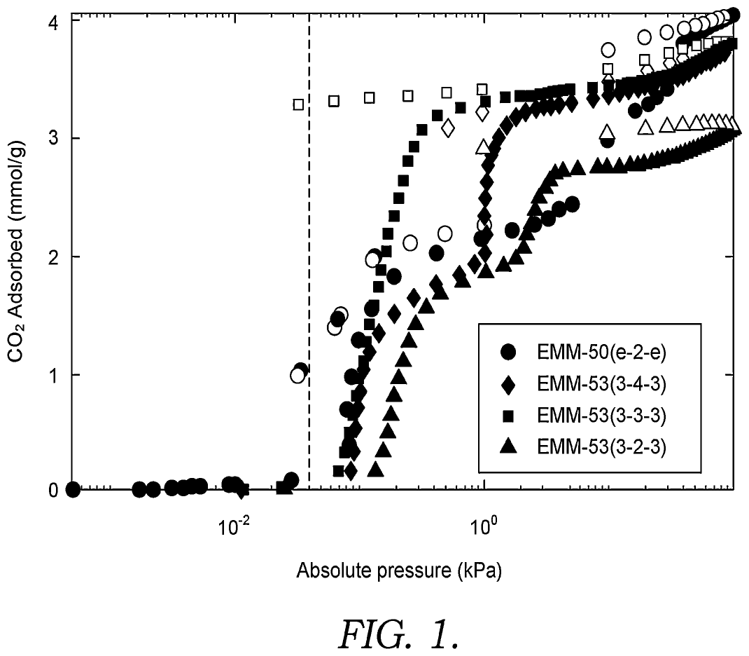

FIG. 1 shows CO₂ adsorption isotherms of EMM-53(3-2-3), EMM-53(3-3-3), EMM-53(3-4-3), and EMM-50(e-2-e) at 75° C. All isotherms in FIG. 1 indicate that at room temperature the samples will have significant CO₂ uptake at partial pressures of 400 ppm CO₂ because the step onset will move to lower CO₂ partial pressures at lower temperatures.

To evaluate kinetics of these samples near room temperature, a CO₂ uptake test was carried out by thermogravimetric analysis (TGA) where the samples were activated at 180° C. (EMM-53) or 140° C. (EMM-50) for 4 hours under N₂ and cooled to 35° C. before the inlet gas was switched to approximately 80% CO₂ in N₂. This procedure was used so that substantially all CO₂ would be desorbed prior to starting the uptake test. It is noted that due to the unexpected location of the step in the isotherm for EMM-50(e-2-e), 140° C. was sufficient to achieve substantially complete desorption of any CO₂.

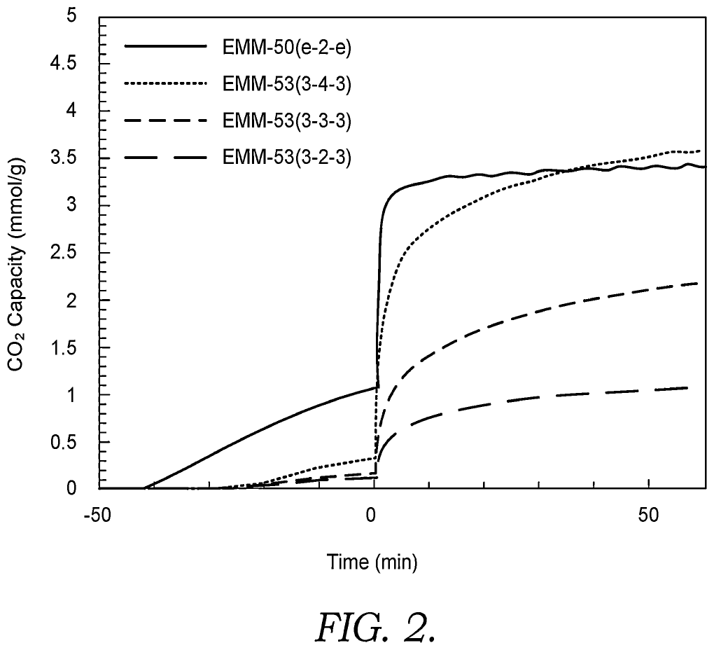

The CO₂ uptake at 35° C. vs time is plotted in FIG. 2. The EMM-53 samples are able to capture 96%, 58%, and 36% of their expected equilibrium capacities after a 1 hour exposure to 80% CO₂. In contrast, EMM-50(e-2-e) is able to capture 88% of its expected equilibrium capacity near instantaneously upon exposure to CO₂.

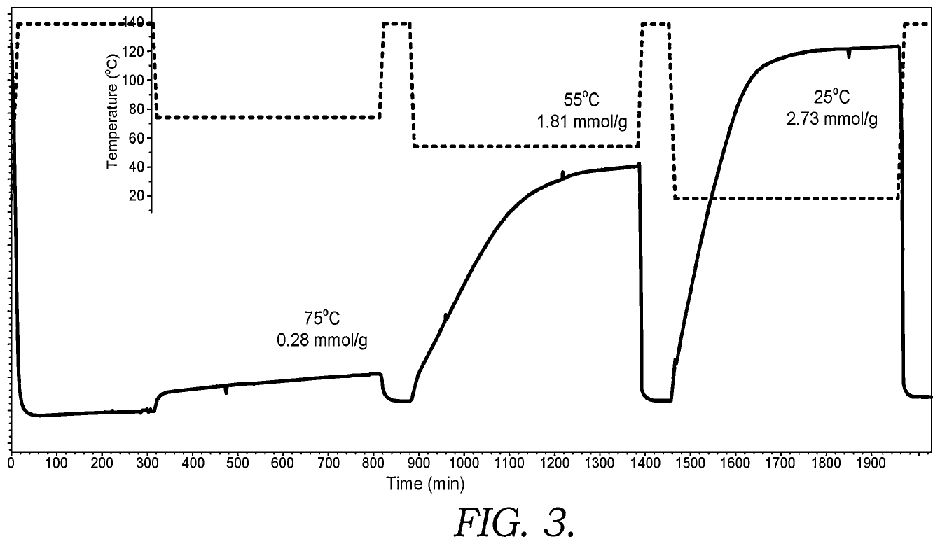

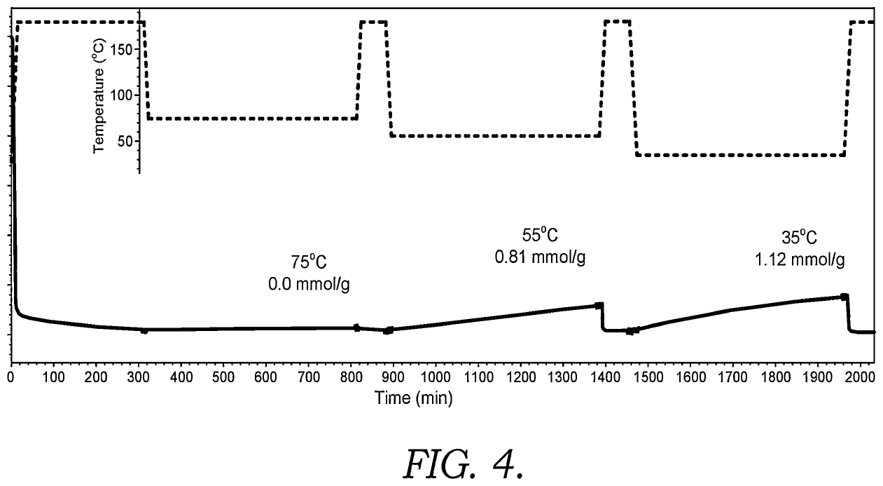

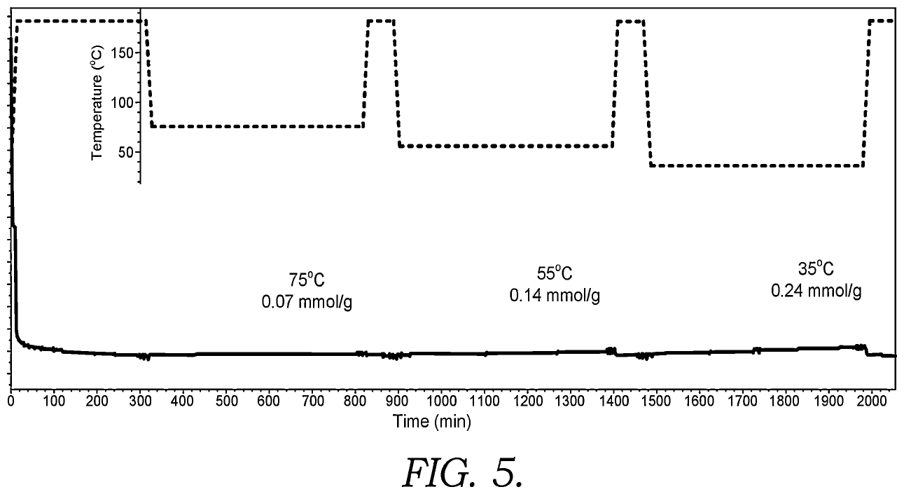

To further expand on the differentiated performance of EMM-50(e-2-e), the samples were exposed to 400 ppm CO₂ at 25° C. or 35° C., 55° C., and 75° C. in a thermogravimetric experiment. FIG. 3 shows the results for EMM-50(e-2-e), FIG. 4 shows the results for EMM-53(3-4-3), and FIG. 5 shows the results for EMM-53(3-3-3). In FIG. 3, FIG. 4, and FIG. 5, the lower line shows the amount of CO₂ sorption while the upper line represents the temperature. The bottom axis is time of exposure. In each of FIG. 3, FIG. 4, and FIG. 5, there is an initial 300 minute (5 hour) exposure in N₂ at 180° C. to fully desorb water and CO₂ from the sample. The samples are then exposed at the indicated temperature to the 400 ppm of CO₂ for the indicated period of time.

At the lowest temperature studied in these experiments, EMM-50(e-2-e) was able to adsorb 2.8 mmol/g after an 8 hour exposure. In contrast, EMM-53(3-4-3) and EMM-53(3-3-3) were only able to achieve CO₂ capacities of 1.12 and 0.24 mmol/g, respectively. Additionally, EMM-50(e-2-e) was able to reach equilibrium after 4 hours time-on-stream, whereas the other materials did not reach their equilibrium adsorption even after 8 hours exposure to 400 ppm CO₂, suggesting the kinetics of CO₂ adsorption are faster in EMM-50(e-2-e) in comparison to EMM-53 samples.

### Example 5—Maintaining Capacity Across Sorption/Desorption Cycles

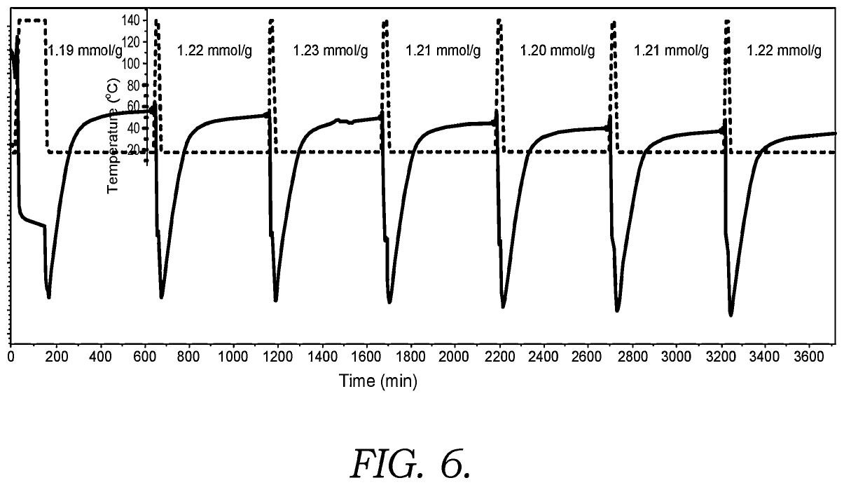

FIG. 6 shows EMM-50(e-2-e) cycling between 18° C. and 140° C. under a constant stream of 400 ppm CO₂. The material is able to desorb the CO₂ completely at 140° C. owing to its step-shaped isotherm. The cycle capacity is maintained throughout all seven cycles studied in this experiment.

### ADDITIONAL EMBODIMENTS

Embodiment 1. A sorbent composition, comprising: a mixed-metal organic framework comprising: two or more metals selected from Mg, Ca, Sc, Ti, V, Mn, Cr, Fe, Co, Ni, Cu and Zn, and a linker comprising 4,4′-dioxidobiphenyl-3,3′-dicarboxylate, 3,3′-dioxidobiphenyl-4,4′-dicarboxylate, or a combination thereof; and N,N′-diethylethylenediamine.

Embodiment 2. The sorbent composition of Embodiment 1, wherein the mixed-metal organic framework is represented by the formula M¹ₓM²₍₂₋ₓ₎ 4,4′-dioxidobiphenyl-3,3′-dicarboxylate, where M¹ is different from M² and where x is from 0.01 to 1.99.

Embodiment 3. The sorbent composition of Embodiment 2, wherein x is from 0.1 to 1.9.

Embodiment 4. The sorbent composition of Embodiment 2, wherein x is from 0.5 to 1.5.

Embodiment 5. The sorbent composition of any of the above embodiments, wherein the sorbent composition comprises a loading of N,N′-diethylethylenediamine of 20% to 80% relative to the number of metal sites in the mixed-metal organic framework, as determined by NMR.

Embodiment 6. The sorbent composition of any of the above embodiments, wherein the two or more metals are selected from Ni, Mn, Mg, and Zn.

Embodiment 7. The sorbent composition of any of the above embodiments, wherein the two or more metals are Mn and Mg.

Embodiment 8. The sorbent composition of any of the above embodiments, further comprising 1.0 mmol CO₂ or more per gram of the sorbent composition.

Embodiment 9. The sorbent composition of any of the above embodiments, wherein the sorbent composition is supported on at least one of a monolith, particles of a packed bed, a hollow fiber, or a combination thereof.

Embodiment 10. A method for separating CO₂ from a feed, comprising: contacting a sorbent composition according to any of the above embodiments in a sorbent environment with an input flow comprising 600 vppm or less of CO₂ to form a CO₂-loaded sorbent and a sorption output flow with a CO₂ content lower than the CO₂-containing input flow.

Embodiment 11. The method of Embodiment 10, further comprising desorbing CO₂ from the sorbent by exposing the CO₂-loaded sorbent to a desorption input flow to form a CO₂-depleted sorbent and a desorption output flow, the desorption input flow optionally comprising steam.

Embodiment 12. The method of Embodiment 11, wherein the desorption input flow comprises a temperature of 140° C. or less, or wherein the sorbent environment comprises a temperature of 140° C. or less during the desorbing, or a combination thereof.

Embodiment 13. The method of Embodiment 11 or 12, wherein a pressure in the sorbent environment during the desorbing is lower than a pressure in the sorbent environment during the contacting by 20 kPa or more.

Embodiment 14. The method of any of Embodiments 10-13, wherein the input flow comprises air; or wherein the sorbent composition is contacted with the input flow at a pressure of 80 kPa-a to 500 kPa-a; or a combination thereof.

Embodiment 15. The method of any of Embodiments 10-14, wherein the sorbent composition is supported on at least one of a monolith, particles of a packed bed, a hollow fiber, or a combination thereof.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A sorbent composition, comprising:
a mixed-metal organic framework comprising:
two or more metals selected from Mg, Ca, Sc, Ti, V, Mn, Cr, Fe, Co, Ni, Cu and Zn, and
a linker comprising 4,4′-dioxidobiphenyl-3,3′-dicarboxylate, 3,3′-dioxidobiphenyl-4,4′-dicarboxylate, or a combination thereof; and
N,N′-diethylethylenediamine.

2. The sorbent composition of claim 1, wherein the mixed-metal organic framework is represented by the formula
M¹ₓM²₍₂₋ₓ₎ 4,4′-dioxidobiphenyl-3,3′-dicarboxylate, where M¹ is different from M² and where x is from 0.01 to 1.99.

3. The sorbent composition of claim 2, wherein x is from 0.1 to 1.9.

4. The sorbent composition of claim 2, wherein x is from 0.5 to 1.5.

5. The sorbent composition of claim 1, wherein the sorbent composition comprises a loading of N,N′-diethylethylenediamine of 20% to 80% relative to the number of metal sites in the mixed-metal organic framework, as determined by NMR.

6. The sorbent composition of claim 1, wherein the two or more metals are selected from Ni, Mn, Mg, and Zn.

7. The sorbent composition of claim 1, wherein the two or more metals are Mn and Mg.

8. The sorbent composition of claim 1, further comprising 1.0 mmol CO₂ or more per gram of the sorbent composition.

9. The sorbent composition of claim 1, wherein the sorbent composition is supported on at least one of a monolith, particles of a packed bed, a hollow fiber, or a combination thereof.

10. A method for separating CO₂ from a feed, comprising:
contacting a sorbent composition in a sorbent environment with an input flow comprising 600 vppm or less of CO₂ to form a CO₂-loaded sorbent and a sorption output flow with a CO₂ content lower than the CO₂-containing input flow,
wherein the sorbent composition comprises a mixed-metal organic framework comprising:
two or more metals selected from Mg, Ca, Sc, Ti, V, Mn, Cr, Fe, Co, Ni, Cu and Zn, and
a linker comprising 4,4′-dioxidobiphenyl-3,3′-dicarboxylate, 3,3′-dioxidobiphenyl-4,4′-dicarboxylate, or a combination thereof; and
N,N′-diethylethylenediamine.

11. The method of claim 10, further comprising desorbing CO₂ from the sorbent by exposing the CO₂-loaded sorbent to a desorption input flow to form a CO₂-depleted sorbent and a desorption output flow.

12. The method of claim 11, wherein the desorption input flow comprises a temperature of 140° C. or less, or wherein the sorbent environment comprises a temperature of 140° C. or less during the desorbing, or a combination thereof.

13. The method of claim 11, wherein a pressure in the sorbent environment during the desorbing is lower than a pressure in the sorbent environment during the contacting by 20 kPa or more.

14. The method of claim 11, wherein the desorption input flow comprises steam.

15. The method of claim 10, wherein the sorbent composition is contacted with the input flow at a pressure of 80 kPa-a to 500 kPa-a.

16. The method of claim 10, wherein the input flow comprises air.

17. The method of claim 10, wherein the sorbent composition is supported on at least one of a monolith, particles of a packed bed, a hollow fiber, or a combination thereof.

18. The method of claim 10, wherein the mixed-metal organic framework is represented by the formula
M¹ₓM²₍₂₋ₓ₎ 4,4′-dioxidobiphenyl-3,3′-dicarboxylate, where M¹ is different from M² and where x is from 0.01 to 1.99.

19. The method of claim 10, wherein x is from 0.1 to 1.9.

20. The method of claim 10, wherein x is from 0.5 to 1.5.
